(19) United States
(12) Patent Application Publication
(10) Pub. No.: US 2013/0286989 A1
(43) Pub. Date: Oct. 31, 2013

(54) METHOD AND SYSTEM FOR TRANSMITTING SERVICE DATA

(71) Applicants: Yun Zhu, Shenzhen (CN); Chun Huang, Shenzhen (CN)

(72) Inventors: Yun Zhu, Shenzhen (CN); Chun Huang, Shenzhen (CN)

(73) Assignee: ZTE Corporation, Shenzhen, Guangdong Province (CN)

(21) Appl. No.: 13/978,379

(22) PCT Filed: May 6, 2011
(86) PCT No.: PCT/CN11/73783

§ 371 Date: Jul. 3, 2013

(30) Foreign Application Priority Data
Jan. 5, 2011 (CN) 201110001440.5

(51) Int. Cl. H04W 72/04

(52) U.S. Cl. CPC H04W 72/0406
USPC 370/329

(57) ABSTRACT

The disclosure discloses a method and a system for transmitting service data, in the method, User Equipment (UE) in the state of Cell Forward Access Channel (CELL_FACH) establishing Radio Resource Control (RRC) connection with the base station, the UE monitoring High Speed Shared Control Channel (HS-SCCH), acquiring control information for establishing High Speed Downlink Shared Channel (HS-DSCH) on the HS-SCCH, establishing HS-DSCH by adopting the control information and performing transmission of service data with the base station on the HS-DSCH. With the technical scheme of the disclosure, service data can be transmitted at a high speed (for example, “Always on” service data) and user experience can be effectively improved.

### FIELD OF THE INVENTION

The disclosure relates to the field of communications, and in particular to a method and a system for transmitting service data.

### BACKGROUND OF THE INVENTION

With the development of wireless communications, types of service gradually are varied, not only limited to traditional voice and short message service. There is some “Always on” service of frequent transmission and a small data size, for example, service like Email, private network connection or the like, wherein the service can be performed on the backstage without need of users' interference, but data transmission needs to be always on.

For service like that, if adopting a traditional access method, which means at first forwarding User Equipment (UE) in the state of Cell Forward Access Channel (CELL_FACH) to the state of Cell Dedicated Channel (CELL_DCH) by paging or establishing a dedicated wireless channel, then sending or receiving user data; obviously, there would be extra signaling overhead, and an interaction process of signaling would increase time-delay of service establishment so as to decrease user experience. And if keeping the user in the state of CELL_FACH and using public channels to bear the service, because a data rate of the public channels is low, a transmission rate is comparatively low.

In a word, relative technologies are lack of schemes that can make a terminal receive and send “Always on” service data at a high data rate in the state of CELL_FACH.

### SUMMARY OF THE INVENTION

The disclosure provides a method and a system for transmitting service data to solve the issue of a low transmission rate caused by bearing “Always on” service data by use of public channels in the state of CELL_FACH in the relative technologies at least.

According to one aspect of the disclosure, it provides a method for transmitting service data.

The method for transmitting service data of the disclosure comprises: a UE in the state of CELL_FACH establishing Radio Resource Control (RRC) connection with a base station; the UE monitoring High Speed Shared Control Channel (HS-SCCH), and acquiring control information for establishing High Speed Downlink Shared Channel (HS-DSCH) on the HS-SCCH; and the UE establishing HS-DSCH by adopting the control information and performing transmission of service data with the base station on the HS-DSCH.

Before the UE establishing RRC connection with the base station, the method further comprises: the base station notifying a Radio Network Control (RNC) of a data transmission capability of corresponding cell in the state of CELL_FACH; and the base station receiving a public Media Access Layer D (MAC-D) and a public Radio Network Temporary Identifier (RNTI) which are returned from the RNC.

The base station notifies the RNC of the data transmission capability through an auditing response and a resource status indication.

The RNC returns the public MAC-D and the public RNTI to the base station by carrying in physical shared resources reconfiguration request.

The UE establishing RRC connection with the base station comprises: the base station receiving a RRC connection establishment request from the UE in the state of CELL_FACH; the base station sending the received RRC connection establishment request to RNC through an Frame Protocol (FP), wherein the RRC connection establishment request carries an Enhanced Radio Network Temporary Identifier (E-RNTI) assigned to the UE from the base station; the base station receiving a RRC connection establishment response from the RNC sent through the FP, wherein the RRC connection establishment response carries a High Speed Downlink Shared Channel Radio Network Temporary Identifier (H-RNTI) and the E-RNTI which are assigned to the UE; and the base station sending the RRC connection establishment response to the UE.

When data is user plane data, the UE monitoring HS-SCCH comprises: the UE performing a reading operation on the fifth System Information Block (SIB5); and the base station notifying the UE of receiving the user plane data through the HS-SCCH.

When data is control plane data, the UE monitoring HS-SCCH comprises: the UE selecting one public H-RNTI according to the number of public H-RNTIs broadcasted by SIB5 and an initial UE identity; and the UE monitoring the HS-SCCH by use of the selected public H-RNTI.

The service data is “Always on” service data.

According to the other aspect of the disclosure, it provides a system for transmitting service data.

The system for transmitting service data of the disclosure comprises: a base station and a UE in the state of CELL_FACH; wherein the UE comprises: a first establishing module, configured to establish RRC connection with the base station; a monitoring module, configured to monitor HS-SCCH, and acquire control information for establishing HS-DSCH on the HS-SCCH; a second establishing module, configured to establish HS-DSCH by adopting the control information; and a first transmitting module, configured to perform transmission of service data with the base station on the HS-DSCH; and the base station comprises: a third establishing module, configured to establish the RRC connection with the UE; and a second transmitting module, configured to perform transmission of service data with the UE on the HS-DSCH.

The base station further comprises: a notifying module, configured to notify a RNC of a data transmission capability of corresponding cell in the state of CELL_FACH; and a receiving module, configured to receive a public MAC-D and a public RNTI which are returned from the RNC.

The monitoring module comprises: a reading unit, configured to perform a reading operation on SIB5; and a receiving unit, configured to receive notification from the base station through the HS-SCCH, wherein the notification is used for indicating the UE to receive user plane data.

The monitoring module comprises: a selecting unit, configured to select one public H-RNTI according to the number of public H-RNTIs broadcasted by SIB5 and an initial UE identity; and a monitoring unit, configured to monitor the HS-SCCH by use of the selected public H-RNTI.

The service data is “Always on” service data.

Through the disclosure, the UE in the state of CELL_FACH monitors the HS-SCCH after establishing RRC connection with the base station, and performs transmission of service data with the base station on the HS-DSCH corresponding to the HS-SCCH. The issue of bearing “Always on” service data by use of public channels in the state of CELL_FACH in the relative technologies is solved to further transmit service data at a high speed (for example, “Always on” service data) and improve user experience effectively.

### BRIEF DESCRIPTION OF THE DRAWINGS

The drawings of brief description here are used for providing further understanding of the disclosure, consisting of a part of this disclosure. Illustrative embodiments and brief descriptions of the disclosure are used for making the disclosure clear, not subjected to improper limitation of the disclosure. In the drawings:

FIG. 1 is a flowchart of a method for transmitting service data according to an embodiment of the disclosure;

FIG. 2 is a schematic flowchart of a method for transmitting service data according to the first preferred embodiment of the disclosure;

FIG. 3 is a schematic flowchart of a method for transmitting service data according to the second preferred embodiment of the disclosure;

FIG. 4 is a structure diagram of a system for transmitting service data according to an embodiment of the disclosure; and

FIG. 5 is a structure diagram of a system for transmitting service data according to the preferred embodiment of the disclosure.

### DETAILED DESCRIPTION OF THE EMBODIMENTS

In the following text, reference drawings and embodiments are combined to elaborate on the disclosure. What's needed to say, under the condition of no conflicts, the embodiments of the disclosure and characteristics of the embodiments can be mutually matched.

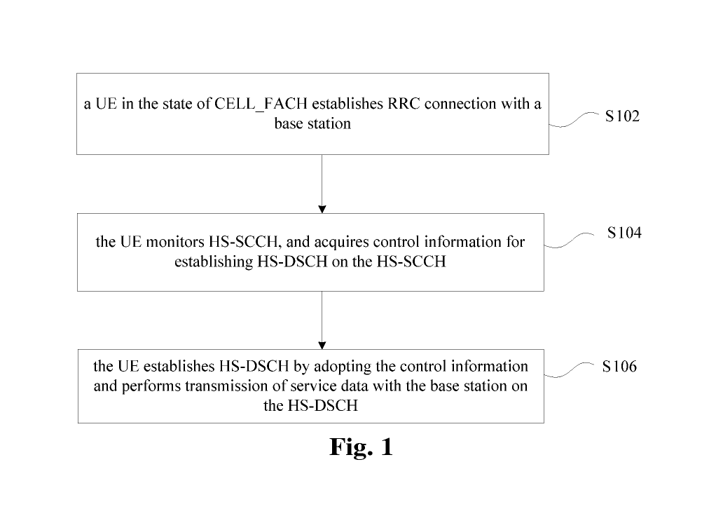

FIG. 1 is a flowchart of a method for transmitting service data according to the embodiment of the disclosure. Illustrated according to FIG. 1, the method for transmitting service data mainly comprises processing as follows.

Step S102: a UE in the state of CELL_FACH establishes RRC connection with a base station;

Step S104: the UE monitors HS-SCCH, and acquires control information for establishing HS-DSCH on the HS-SCCH; and

Step S106: the UE establishes HS-DSCH by adopting the control information and performs transmission of service data with the base station on the HS-DSCH.

In the method, a terminal establishes HS-DSCH to perform transmission of service data with the base station on the HS-DSCH. The terminal can receive and send “Always on” service data at a high data rate in the state of CELL_FACH without need of entering the state of CELL_DCH so as to improve user experience effectively.

In the above, the service data is not only limited to “Always on” service data, but can be service data of other types.

Preferably, before performing Step S102, further comprising processing as follows:

(1) the base station notifies a RNC of a data transmission capability of the corresponding cell in the state of CELL_FACH;

in the preferred implementation process, the base station notifies the RNC of the data transmission capability through an auditing response and a resource status indication.

(2) the base station receives a public MAC-D and a public RNTI which are returned from the RNC.

In the preferred implementation process, the RNC returns the public MAC-D and the public RNTI to the base station by carrying in physical shared resources reconfiguration request.

Preferably, Step S102 may further comprise the following processing:

(1) the base station receives a RRC connection establishment request from the UE in the state of CELL_FACH;

(2) the base station sends the received RRC connection establishment request to the RNC through an FP, wherein the RRC connection establishment request carries an E-RNTI assigned to the UE from the base station;

(3) the base station receives a RRC connection establishment response from the RNC sent through the FP, wherein the RRC connection establishment response carries a H-RNTI and the E-RNTI which are assigned to the UE; and

(4) the base station sends the RRC connection establishment response to the UE.

Preferably, when data is user plane data, Step S106 may further comprise the following processing:

(1) the UE performs a reading operation on the SIB5; and

(2) the base station notifies the UE of receiving the user plane data through the HS-SCCH.

Preferably, when the data is control plane data, Step S106 may further comprise the following processing:

(1) the UE selects one public H-RNTI according to the number of public H-RNTIs broadcasted by the SIB5 and an initial UE identity; and

(2) the HS-SCCH is monitored by the UE by use of the selected public H-RNTI.

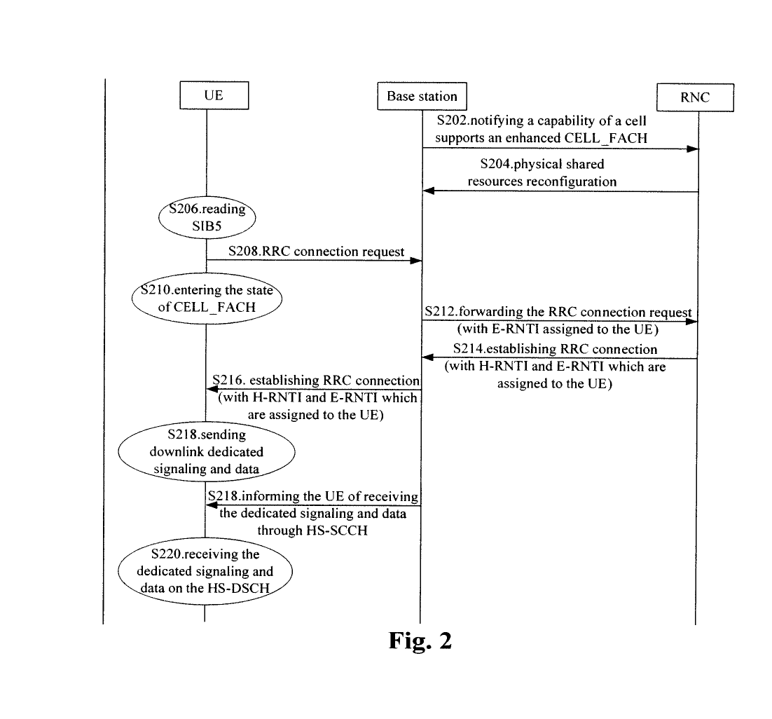

The following describes a preferred implementation way of UE transmitting Dedicated Control Channel (DCCH)/Dedicated Traffic Channel (DTCH) data (user plane data) in the state of CELL_FACH on HS-DSCH in combination with FIG. 2.

FIG. 2 is a schematic flowchart of a method for transmitting service data according to the first preferred embodiment of the disclosure. Illustrated according to FIG. 2, the method of data access mainly comprises the following processing.

In the initial state, a High Speed Packet Access (HSPA) cell is established at a base station (NodeB), the UE is resided in the cell, and the UE is in the idle mode. The HSPA cell specifically means a cell in the wireless coverage for supporting High Speed Downlink Packet Access (HSDPA) or High Speed Uplink Packet Access (HSUPA). The UE physically supports receiving and sending HSDPA data or HSUPA data in the state of CELL_FACH.

Step S202, the NodeB notifies the RNC of a data transmission capability of the cell in the state of CELL_FACH through an auditing response or a resource status indication;

further, the data transmission capability of the cell in the state of CELL_FACH must be a capability that the DCCH/DTCH on the HS-DSCH can send and receive data, which means resource auditing response or resource status indication sent by the NodeB contain indication of “Enhanced Forward Access Channel (FACH) Capability”.

Step S204, the RNC assigns the public MAC-D and the public RNTI to the NodeB by a physical shared resources reconfiguration request;

further, the physical shared resources reconfiguration request sent by the RNC contains “HS-DSCH Common System Information Low Chip Rate (LCR)”, wherein parameter items of “Broadcast Control Channel (BCCH) Specific HS-DSCH RNTI Information LCR” and “HS-DSCH Paging System Information LCR” are included.

Step S206, the UE reads system information SIB5;

further, the system information block SIB5 includes “HS-DSCH Common System Information”, further, the “HS-DSCH Common System Information” includes information units such as “HS-SCCH system info” and “Common H-RNTI Information” or the like.

Step S208, the UE sends a RRC connection establishment request message to the cell;

wherein the RRC connection establishment request message includes “High Speed Physical Downlink Shared Channel (HS-PDSCH) in CELL_FACH”.

Step S210, the UE enters the state of CELL_FACH.

Step S212, the NodeB sends the RRC connection establishment request message to the RNC through an FP, the RRC connection establishment request message is carried with E-RNTI assigned by the NodeB to the UE.

Step S214, the RNC assigns corresponding H-RNTI and sends a RRC connection establishment response message to the NodeB through the FP, the RRC connection establishment response message is carried with the H-RNTI and the E-RNTI which are assigned to the UE.

Step S216, the NodeB sends the H-RNTI and the E-RNTI which are assigned to the UE and the RRC connection establishment response message to the UE.

Step S218, the process that sending downlink dedicated signaling and data to the UE is triggered, the cell notifies the UE of receiving the dedicated signaling and data through HS-SCCH.

Step S220, after receiving the HS-SCCH, the UE receives the dedicated signaling and data on the corresponding HS-DSCH.

Meanwhile, the UE monitors UE dedicated H-RNTI on the HS-SCCH and detects dedicated H-RNTI of the UE, the UE receives the DCCH/DTCH on the corresponding HS-DSCH Transmission Time Interval (TTI).

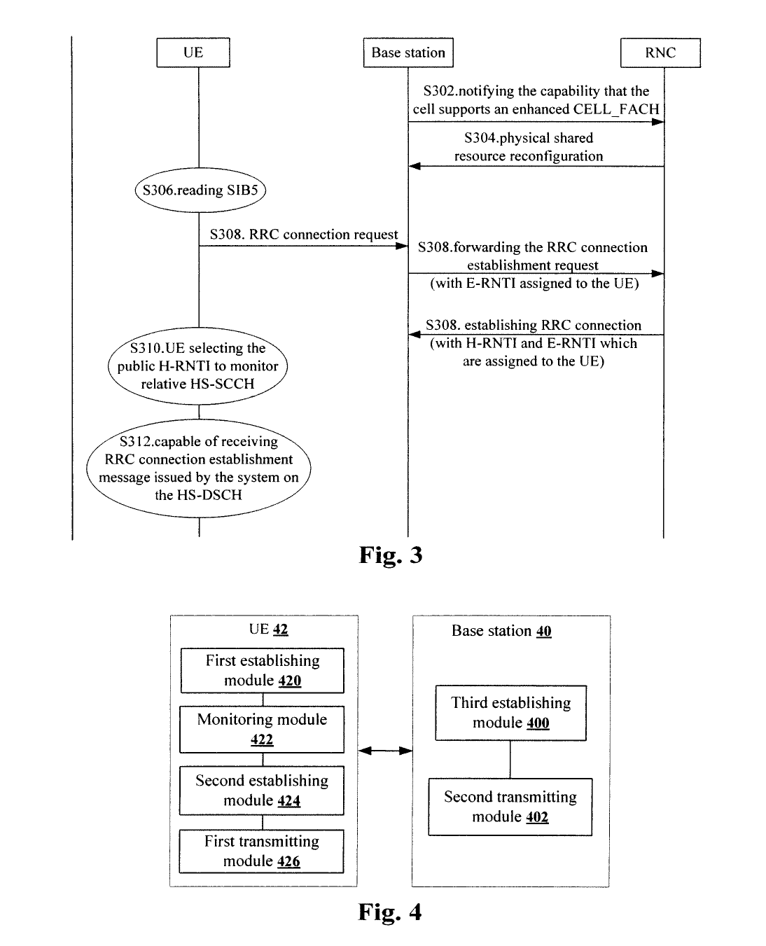

The following describes a preferred implementation way of UE transmitting DCCH/DTCH data (control plane data Signaling Radio Bearer (SRB0)) in the state of CELL_FACH on HS-DSCH in combination with FIG. 3.

FIG. 3 is a schematic flowchart of a method for transmitting service data according to the second preferred embodiment of the disclosure. As shown in FIG. 3, the method for transmitting service data mainly comprises the following processing.

In the initial state, a HSPA cell with a function of supporting enhanced CELL_FACH is established at a base station (NodeB), the UE is resided in the cell, and the UE is in the idle mode. The HSPA cell specifically means a cell in the wireless coverage for supporting HSDPA or HSUPA. The UE physically supports receiving and sending HSDPA data or HSUPA data in the state of CELL_FACH.

Step S302, the NodeB notifies the RNC of the capability that the cell supports enhancement of the CELL_FACH through an auditing response or a resource status indication;

further, the capability that the cell supports enhancement of CELL_FACH means an auditing response or a resource status indication sent by the NodeB includes indication of “Enhanced FACH Capability”.

Step S304, the RNC assigns the public MAC-D and the public RNTI to the NodeB through a physical shared resources reconfiguration request;

further, the physical shared resources reconfiguration request sent by the RNC includes “HS-DSCH Common System Information LCR”.

Step S306, the UE reads system information SIB5;

and, the SIB5 includes “HS-DSCH common system information”, and the “HS-DSCH common system information” includes Internet Explorer (IE) parameters such as “HS-SCCH system info”, “Common Control Channel (CCCH) mapping info” and “Common H-RNTI Information” or the like;

the UE selects one public H-RNTI according to the number of public H-RNTIs broadcasted by the SIB5 and an “Initial UE Identity”, the UE monitors the public H-RNTI on the HS-SCCH, if the public H-RNTI is detected, the UE receives CCCH (SRB0) on the corresponding HS-DSCH TTI.

Step S308, the UE initiates RRC connection establishment process in the cell;

wherein the RRC connection establishment request message includes parameter of “HS-PDSCH in CELL_FACH”.

Step S310, the UE selects the public H-RNTI to monitor relative HS-SCCH.

Step S312, the UE acquires control information for establishing a HS-DSCH on the HS-SCCH, establishes HS-DSCH by adopting the control information and transmits CCCH data with the NodeB on the HS-DSCH, wherein the data is carried with RRC CONNECTION SETUP.

At this time, the UE is capable of receiving RRC CONNECTION SETUP message issued by the system on the HS-DSCH.

FIG. 4 is a structure diagram of the system for transmitting service data according to an embodiment of the disclosure. Illustrated according to FIG. 4, the system for transmitting service data mainly includes: a base station 40 and a UE 42 in the state of CELL_FACH.

In the above, the UE 42 further includes:

a first establishing module 420, configured to establish RRC connection with the base station;

a monitoring module 422, configured to monitor HS-SCCH, and acquire control information for establishing HS-DSCH on the HS-SCCH;

a second establishing module 424, configured to establish HS-DSCH by adopting the control information; and

a first transmitting module 426, configured to perform transmission of service data with the base station on the HS-DSCH.

In the above, the base station 40 further includes:

a third establishing module 400, configured to establish RRC connection with the UE; and

a second transmitting module 402, configured to perform transmission of service data with the UE on the HS-DSCH.

In the system, the terminal establishes HS-DSCH to perform transmission of service data with the base station on the HS-DSCH. The terminal can receive and send “Always on” service data at a high data rate in the state of CELL_FACH without need of entering the state of CELL_DCH so as to improve user experience effectively.

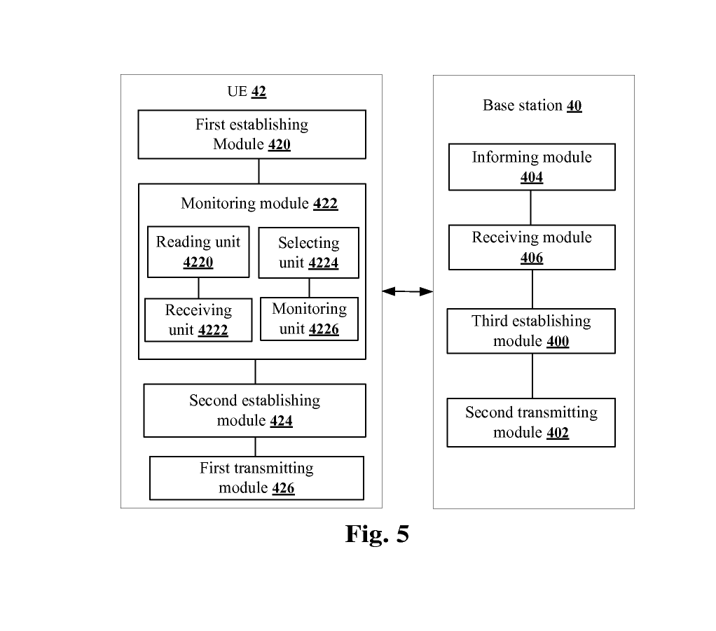

Preferably, illustrated according to FIG. 5, the base station 40 further includes: a notifying module 404, configured to notify a RNC of a data transmission capability of the corresponding cell in the state of CELL_FACH; and a receiving module 406, configured to receive a public MAC-D and a public RNTI which are returned from the RNC.

Preferably, illustrated according to FIG. 5, when data needed to be transmitted is user plane data, the monitoring module 422 further includes: a reading unit 4220, configured to perform a reading operation on the SIB5; and a receiving unit 4222, configured to receive the notification from the base station through the HS-SCCH, wherein the notification is used for indicating the UE to receive the user plane data.

Preferably, illustrated according to FIG. 5, when data needed to be transmitted is control plane data, the monitoring module 422 includes: a selecting unit 4224, configured to select one public H-RNTI according to the number of public H-RNTIs broadcasted by the SIB5 and an initial UE identity; and a monitoring unit 4226, configured to monitor the HS-SCCH by use of the selected public H-RNTI.

Note that, the preferred implementation way of combination of the base station and the UE in the system can be specifically referred to descriptions from FIG. 1 to FIG. 3, there is no further unnecessary descriptions.

In sum, due to the embodiment of the disclosure, after establishing RRC connection between the UE in the state of CELL_FACH and the base station, the UE monitors the HS-SCCH and perform transmission of service data with the base station on the HS-DSCH corresponding with the HS-SCCH. Therefore, the terminal can perform transmission of service data (for example, “Always on” service data) with the base station without need of entering the state of CELL_DCH, decreasing extra signaling overhead, reducing time-delay upon service establishment so as to be capable of receiving and sending service data at a high data rate and improve use experience effectively.

Obviously, technicians of the field should understand, each module or step the disclosure can be implemented by universal computing devices, which can be concentrated on a single computing device or distributed on a network consisting of a plurality of computing devices, optionally, which can be implemented by program codes executable by the computing devices, thus, they can be stored in storage devices to be executed by the computing devices, and in certain cases, the illustrated or described steps can be executed in an order different from the disclosure, or it is implemented by separately manufacturing them into each integrated circuit module, or manufacturing a plurality of modules or steps therein to single circuit modules. Thus, the disclosure is not limited to a combination between any dedicated hardware and software.

The above is only the preferred embodiment of the disclosure and not intended to limit the disclosure, for technicians of the field, any alterations and variations are acceptable. Any modifications, equivalent replacements, improvements and the like within the spirit and principle of the disclosure shall fall within the scope of protection of the disclosure.

1. A method for transmitting service data, comprising:
a User Equipment (UE) in the state of Cell Forward Access Channel (CELL_FACH) establishing Radio Resource Control (RRC) connection with a base station;
the UE monitoring High Speed Shared Control Channel (HS-SCCH), and acquiring control information for establishing High Speed Downlink Shared Channel (HS-DSCH) on the HS-SCCH; and
the UE establishing HS-DSCH by adopting the control information and performing transmission of service data with the base station on the HS-DSCH.

2. The method according to claim 1, wherein before the UE establishing RRC connection with the base station, the method further comprises:
the base station notifying a Radio Network Control (RNC) of a data transmission capability of corresponding cell in the state of CELL_FACH; and
the base station receiving a public Media Access Layer D (MAC-D) and a public Radio Network Temporary Identifier (RNTI) which are returned from the RNC.

3. The method according to claim 2, wherein the base station notifies the RNC of the data transmission capability through an auditing response and a resource status indication.

4. The method according to claim 2, wherein the RNC returns the public MAC-D and the public RNTI to the base station by carrying in physical shared resources reconfiguration request.

5. The method according to claim 1, wherein the UE establishing RRC connection with the base station comprises:
the base station receiving a RRC connection establishment request from the UE in the state of CELL_FACH;
the base station sending the received RRC connection establishment request to RNC through an Frame Protocol (FP), wherein the RRC connection establishment request carries an Enhanced Radio Network Temporary Identifier (E-RNTI) assigned to the UE from the base station;
the base station receiving a RRC connection establishment response from the RNC sent through the FP, wherein the RRC connection establishment response carries a High Speed Downlink Shared Channel Radio Network Temporary Identifier (H-RNTI) and the E-RNTI which are assigned to the UE; and
the base station sending the RRC connection establishment response to the UE.

6. The method according to claim 1, wherein when data is user plane data, the UE monitoring HS-SCCH comprises:
the UE performing a reading operation on the fifth System Information Block (SIBS); and
the base station notifying the UE of receiving the user plane data through the HS-SCCH.

7. The method according to claim 1, wherein when data is control plane data, the UE monitoring HS-SCCH comprises:
the UE selecting one public H-RNTI according to the number of public H-RNTIs broadcasted by SIBS and an initial UE identity; and
the UE monitoring the HS-SCCH by use of the selected public H-RNTI.

8. The method according to claim 1, wherein the service data is “Always on” service data.

9. A system for transmitting service data, comprising: a base station and a User Equipment (UE) in the state of Cell Forward Access Channel (CELL_FACH);
the UE comprises:
a first establishing module, configured to establish Radio Resource Control (RRC) connection with the base station;
a monitoring module, configured to monitor High Speed Shared Control Channel (HS-SCCH), and acquire control information for establishing High Speed Downlink Shared Channel (HS-DSCH) on the HS-SCCH;
a second establishing module, configured to establish HS-DSCH by adopting the control information; and
a first transmitting module, configured to perform transmission of service data with the base station on the HS-DSCH; and
the base station comprises:
a third establishing module, configured to establish the RRC connection with the UE; and
a second transmitting module, configured to perform transmission of service data with the UE on the HS-DSCH.

10. The system according to claim 9, wherein the base station further comprises:
a notifying module, configured to notify a RNC of a data transmission capability of corresponding cell in the state of CELL_FACH; and
a receiving module, configured to receive a public Media Access Layer D (MAC-D) and a public Radio Network Temporary Identifier (RNTI) which are returned from the RNC.

11. The system according to claim 9, wherein the monitoring module comprises:
a reading unit, configured to perform a reading operation on the fifth System Information Block (SIB5); and
a receiving unit, configured to receive notification from the base station through the HS-SCCH, wherein the notification is used for indicating the UE to receive user plane data.

12. The system according to claim 9, wherein the monitoring module comprises:
a selecting unit, configured to select one public High Speed Downlink Shared Channel Radio Network Temporary Identifier (H-RNTI) according to the number of public H-RNTIs broadcasted by SIB5 and an initial UE identity; and
a monitoring unit, configured to monitor the HS-SCCH by use of the selected public H-RNTI.

13. The system according to claim 9, wherein the service data is “Always on” service data.

14. The method according to claim 2, wherein the service data is “Always on” service data.

15. The method according to claim 3, wherein the service data is “Always on” service data.

16. The method according to claim 4, wherein the service data is “Always on” service data.

17. The method according to claim 5, wherein the service data is “Always on” service data.

18. The method according to claim 6, wherein the service data is “Always on” service data.

19. The method according to claim 7, wherein the service data is “Always on” service data.

20. The system according to claim 10, wherein the service data is “Always on” service data.
